(19) United States
(12) Patent Application Publication
(10) Pub. No.: US 2025/0253745 A1
(43) Pub. Date: Aug. 7, 2025

(54) FAN STATOR FIXING STRUCTURE

(71) Applicant: ASIA VITAL COMPONENTS CO., LTD., New Taipei City (TW)

(72) Inventor: Sung-Wei Sun, New Taipei City (TW)

(21) Appl. No.: 18/583,984

(22) Filed: Feb. 22, 2024

(30) Foreign Application Priority Data
Feb. 1, 2024 (TW) 113104038

(51) Int. Cl. H02K 15/12; F04D 25/06; H02K 3/46

(52) U.S. Cl. CPC H02K 15/12; F04D 25/062; H02K 3/46

(57) ABSTRACT

A fan stator fixing structure includes a fan frame, a bearing cup, and a stator assembly. The fan frame internally has a heat curing section vertically extended from one side of the fan frame. The heat curing section is located between the bearing cup and the stator assembly. When the heat curing section is heated and shaped for a second time, the bearing cup and the stator assembly are fixed to the fan frame at the same time. Therefore, it is able to improve the disadvantages in the conventional fan stator fixing structure that are derived from the procedure of adhesive dispensing, including complicated assembling procedures, relatively long assembling time, and high yield loss.

This application claims the priority benefit of Taiwan patent application number 113104038 filed on Feb. 1, 2024.

### FIELD OF THE INVENTION

The present relates to the field of fan, and more particularly, to a fan stator fixing structure.

### BACKGROUND OF THE INVENTION

Please refer to FIGS. 1A, 1B, and 1C, in which a currently available fan stator fixing structure is shown. As shown, a complete conventional fan 9 usually includes a frame 91 having a base 92, a metal sleeve (central barrel) 94 inserted in a connecting section formed on the base 92, a stator assembly 93 externally fitted around the metal sleeve 94, and a rotor having a plurality of spaced blades mounted around the stator assembly 93.

According to the prior art, to ensure the stator assembly 93 is securely fitted around the metal sleeve 94, a procedure of adhesive dispensing is required. In the adhesive dispensing procedure, first coat an adhesive on an outer surface of the metal sleeve 94 before fitting the stator assembly 93 around the metal sleeve 94. Then, wait until the adhesive is cured, and the stator assembly 93 is bonded to the outer surface of the metal sleeve 94.

In the event of adhesive overflow owing to poor adhesive dispensing, other elements outside the metal sleeve 94 might be affected by the overflowed adhesive and get stuck. Further, any residual adhesive attached to an outer surface of the stator assembly would hinder the stator assembly 93 from dissipating heat therefrom. Also, any unnecessarily dispensed adhesive would easily lead to the occurrence of unbalance counterweight for the fan, causing the fan to shake or vibrate during operation thereof.

Further, the adhesive distributed between the metal sleeve 94 and the stator assembly 93 also prevents heat produced in the metal sleeve 94 during the fan operation from diffusing outward, such that a thermal resistance is formed between the metal sleeve 94 and the stator assembly 93 to adversely cause overheated and burn-out bearings in the metal sleeve 94 and accordingly, failure of the fan.

When the adhesive dispensing procedure is completed in the fan assembling, male threads 941 are formed around an upper outer surface of the metal sleeve 94. A nut 95 is screwed to the male threads 941 using a screw driving tool 96, so as to ensure that the stator assembly 93 is limited from moving axially to separate from the metal sleeve 94.

While the adhesive dispensing procedure and the mounting of the nut 95 to the metal sleeve 94 indeed ensure that the stator assembly 93 would not move axially to separate from the metal sleeve 94, they also consume a lot of time and labor to increase the manufacturing cost of the fan 9.

In brief, the prior art fan stator fixing structure has the following disadvantages:
1. The additional procedures of dispensing adhesive and screwing the nut to the metal sleeve inevitably increase the fan manufacturing cost;
2. The adhesive is possibly subject to deterioration in quality, which leads to reduced fixing effect;
3. It is necessary to form on the metal sleeve with a structure corresponding to the nut 95, such as the male threads 941, which also results in increased working time; and
4. Adhesive overflow and thermal resistance tend to occur after the adhesive dispensing procedure.

It is therefore tried by the inventor to develop an improved fan stator fixing structure to overcome the problems and disadvantages in the prior art fan stator fixing structure.

### SUMMARY OF THE INVENTION

To overcome the problems in the conventional fan stator fixing structure, a primary object of the present invention is to provide an improved fan stator fixing structure that enables a fan stator to be securely fixed to a frame of a fan.

Another object of the present invention is to provide a fan stator fixing structure that enables reduced manufacturing cost of a fan.

A further object of the present invention is to provide a fan stator fixing structure that enables simplified procedures for assembling a fan.

To achieve the above and other objects, the fan stator fixing structure according to the present invention includes a fan frame, a bearing cup, and a stator assembly. The fan frame internally has a heat curing section vertically extended from one side of the fan frame. The bearing cup is inserted in the heat curing section, and the stator assembly is externally fitted on around the heat curing section. When the heat curing section is heated and shaped for a second time, the bearing cup and the stator assembly are securely fixed to the fan frame at the same time.

In the present invention, the heat curing section on the fan frame is made of a thermoplastic material. When the heat curing section is heated and shaped for a second time, the stator assembly externally fitted around the heat curing section and the bearing cup inserted in the heat curing section can be directly fixed to the fan frame at the same time. Therefore, the procedure of dispensing adhesive for fixing the stator assembly to the outer surface of the bearing cup as in the prior art can be saved to shorten the assembling time. Further, other fastening elements for restricting the bearing cup and the stator assembly from moving axially can also be eliminated. Therefore, with the present invention, the fan stator assembly can be fixed to the fan frame with largely reduced time and upgraded efficiency. Various disadvantages in the prior art derived from the procedure of dispensing adhesive are also improved.

### BRIEF DESCRIPTION OF THE DRAWINGS

The structure and the technical means adopted by the present invention to achieve the above and other objects can be best understood by referring to the following detailed description of the preferred embodiment and the accompanying drawings, wherein

FIG. 1A shows a prior art fan stator fixing structure that requires an adhesive dispensing procedure to hold the stator in place on the fan;

FIG. 1B shows the prior art fan stator fixing structure of FIG. 1A that requires a nut mounting process to hold the stator in place on the fan;

FIG. C is an assembled perspective view of the prior art fan stator fixing structure of FIGS. 1A and 1B;

FIG. 2A is an exploded sectional side view of a fan stator fixing structure according to a preferred embodiment of the present invention; and

FIG. 2B is an assembled view of FIG. 2A.

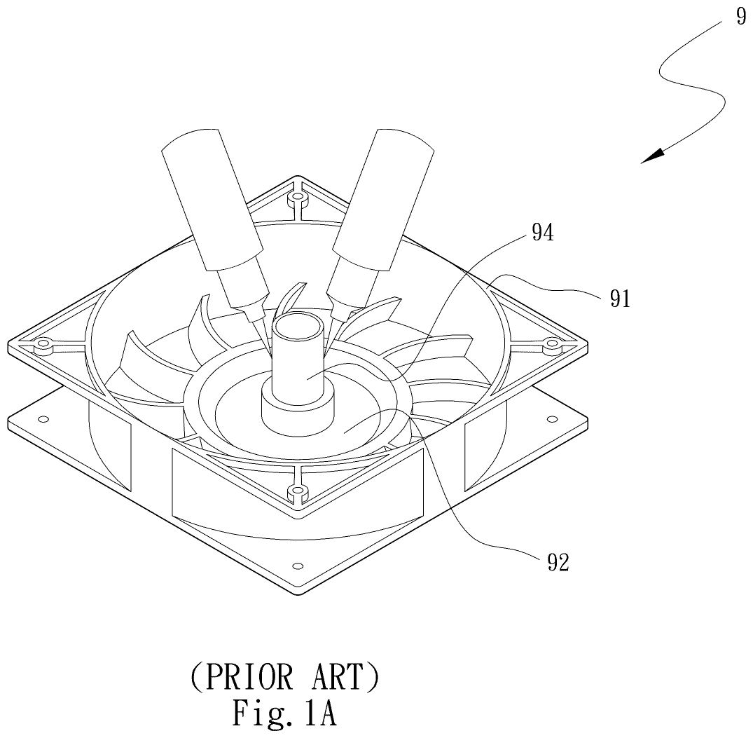

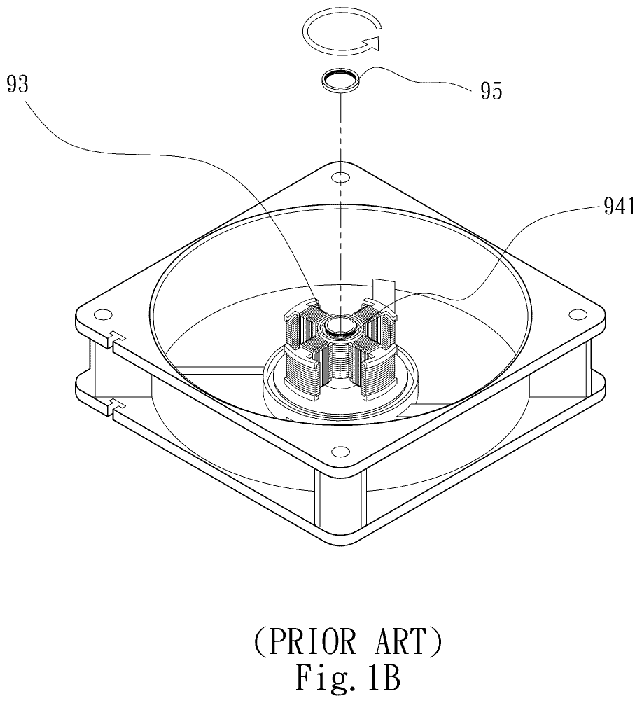

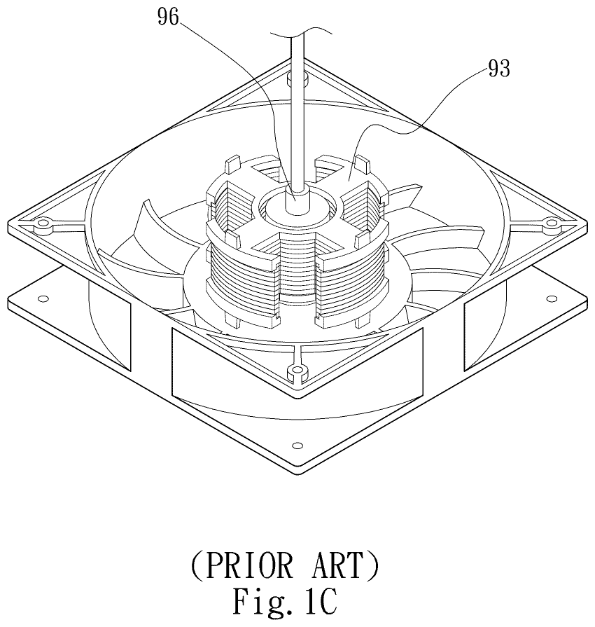

### DETAILED DESCRIPTION OF THE PREFERRED EMBODIMENTS

The present invention will now be described with a preferred embodiment thereof.

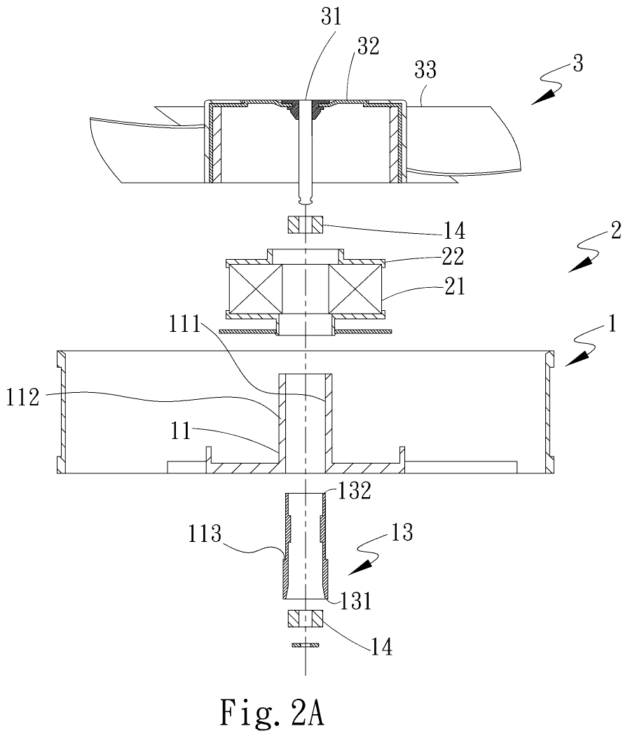

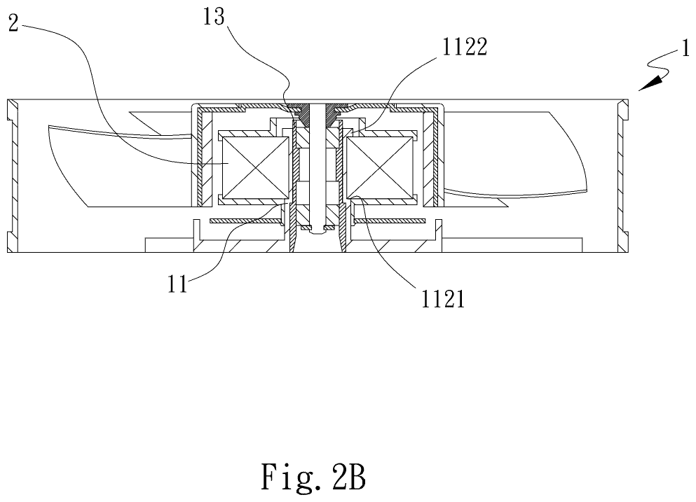

Please refer to FIGS. 2A and 2B, which are exploded and assembled sectional side views, respectively, of a fan stator fixing structure according to a preferred embodiment of the present invention. As shown, a fan stator fixing structure of the present invention includes a fan frame 1, a stator assembly 2, and a rotor assembly 3. A heat curing section 11 in the form of a sleeve (i.e. a central barrel) vertically extended upward from one side of a bottom of the fan frame 1. The heat curing section 11 can be integrally or not integrally formed with the fan frame 1. In the illustrated preferred embodiment, the heat curing section 11 is shown as being integrally formed with the fan frame 1 without being particularly limited thereto. The heat curing section 11 has a first contact surface 111 and a second contact surface 112 formed on an inner wall surface and an outer wall surface thereof, respectively. The heat curing section 11 may be formed of a thermoplastic material and can be heated to shape for a second time.

A bearing cup 13 having a first end 131 and a second end 132 is fitly inserted in the heat curing section 11 and accordingly, wrapped in the heat curing section 11. The bearing cup 13 has an outer surface being in fit contact with the first contact surface 111 of the heat curing section 11, and is internally received a plurality of bearings 14. The bearing cup 13 may be made of a metal or a non-metal material, and has an overall length larger than that of the heat curing section 11. Therefore, the second end 132 of the bearing cup 13 is forward projected beyond the heat curing section 11.

The bearing cup 13 is provided around the outer surface with at least one stepped section 113 or at least one outer diametrical reduced portion. The stepped section 113 is located between the first end 131 and the second end 132 of the bearing cup 13.

The stator assembly 2 includes a set of silicon steel laminations 21, an insulation frame 22, and a set of windings (not shown). The insulation frame 22 and the silicon steel laminations 21 are joined together, the windings are wound around the silicon steel laminations 21, and the assembled stator assembly 2 is fitted on around the second contact surface 112 of the heat curing section 11.

In the present invention, an area of the fan frame 1 for forming the heat curing section 11 or the whole fan frame 1 is made of a thermoplastic material. When the area on the fan frame 1 for forming the heat curing section 11 is heated, cured, and deformed in shape, the bearing cup 13, which is initially inserted and held in the heat curing section 11 in loose fit, is now tightly wrapped by the heat curing section 11. Meanwhile, the heat curing section 11 also covers the stepped section 133. As a result, the bearing cup 13 is limited from moving axially relative to the heat curing section 11.

When the heat curing section 11 is heated to change its shape for a second time, the heat curing section 11 initially loosely fitted in the stator assembly 2 now has its second contact surface 112 tightly attached to inner sides of the stator assembly 2. Further, when the heat curing section 11 is heated for shaping again, since the silicon steel laminations 21 and the insulation frame 22 of the stator assembly 2 have different inner bore sizes, a shoulder section 1121 is formed on the second contact surface 112 at an area where the silicon steel laminations 21 are located adjacent to a lower end of the insulation frame 22 while a limiting section 1122 is formed on the second contact surface 112 at an area close to an upper end of the insulation frame 22; such that the heat curing section 11 serves to limit the stator assembly 2 from moving axially and hold the stator assembly 2 in place.

The rotor assembly 3 includes a shaft 31, a hub 32, and a plurality of blades 33; the shaft 31 is extended vertically downward from a central area of the hub 32; the blades 33 are spaced on an outer sidewall of the hub 32; and the shaft 31 is inserted into the bearing cup 13 to engage with the bearings 14.

In the present invention, since the heat curing section 11 is made of a thermoplastic material, the heat curing section 11 being heated and shaped again can also tightly wrap around the outer surface of the bearing cup 13 and fill up any gap between the bearing cup 13 and the stator assembly 2. After the heat curing section 11 is cured and shaped again, it holds the stator assembly 2 and the bearing cup 13 in place in the fan frame 1 at the same time. With these arrangements, the disadvantages in the prior art fan stator fixing structure derived from the procedure of adhesive dispensing can be improved.

In conclusion, the fan stator fixing structure of the present invention has the following advantages, compared to the prior art:
1. It has relatively simple and stable structure;
2. It can be more easily manufactured; and
3. It requires only reduced manufacturing cost.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A fan stator fixing structure, comprising:
a fan frame internally having a heat curing section vertically extended from one side of the fan frame;
a bearing cup inserted in the heat curing section; and
a stator assembly externally fitted on around the heat curing section; and
wherein the heat curing section can be heated and shaped for a second time, such that the bearing cup and the stator assembly are simultaneously fixed to the fan frame by the heat curing section.

2. The fan stator fixing structure as claimed in claim 1, wherein the heat curing section has an inner surface and an outer surface define a first contact surface and a second contact surface, respectively; the bearing cup having an outer surface in contact with the first contact surface of the heat curing section; and the stator assembly externally fitted on around the heat curing section being in contact with the second contact surface of the heat curing section.

3. The fan stator fixing structure as claimed in claim 1, wherein the heat curing section and the fan frame are integrally formed.

4. The fan stator fixing structure as claimed in claim 1, wherein the stator assembly includes a set of silicon steel laminations, which is externally fitted on around the second contact surface of the heat curing section; and the silicon steel laminations having a lower end in contact with a shoulder section of the heat curing section and an upper end in contact with a limiting section of the heat curing section.

5. The fan stator fixing structure as claimed in claim 1, wherein the bearing cup is made of a metal material.

6. The fan stator fixing structure as claimed in claim 1, wherein the bearing cup has an overall length larger than that of the heat curing section.

7. The fan stator fixing structure as claimed in claim 1, wherein the heat curing section is made of a thermoplastic material.
